(19) United States
(12) Patent Application Publication
(10) Pub. No.: US 2021/0304731 A1
(43) Pub. Date: Sep. 30, 2021

(54) CONTROL DEVICE FOR ELECTRONIC APPARATUS, NON-TRANSITORY COMPUTER-READABLE MEDIUM, CONTROL METHOD, AND ELECTRONIC APPARATUS

(71) Applicant: SHARP KABUSHIKI KAISHA, Sakai City (JP)

(72) Inventors: Shinya Satoh, Sakai City (JP); Kaiko Kuwamura, Sakai City (JP); Hiroshi Wada, Sakai City (JP)

(21) Appl. No.: 17/207,175

(22) Filed: Mar. 19, 2021

(30) Foreign Application Priority Data
Mar. 24, 2020 (JP) 2020-052850

(51) Int. Cl. G10L 15/01; G10L 15/30; G10L 15/32; G06F 11/07

(52) U.S. Cl. CPC G10L 15/01; G10L 15/30; G10L 2015/223; G06F 11/076; G10L 15/32

(57) ABSTRACT

A control device controls an electronic apparatus capable of communicating with an external server and receiving an input of voice information. The control device includes a voice recognition unit and a voice recognition control unit. The voice recognition unit is configured to perform voice information recognition on the inputted voice information. The voice recognition control unit is configured to transmit to the server the voice information and a voice recognition request that the server perform voice information recognition on the voice information and to determine whether or not there has occurred a recognition error in a voice recognition result produced by the server. When there have occurred more recognition errors than a prescribed number, the voice recognition control unit suspends the transmission of the voice recognition request to the server.

### CROSS-REFERENCE TO RELATED APPLICATION

The present application claims priority level from Japanese Application JP2020-52850, the content of which is hereby incorporated by reference into this application.

### BACKGROUND OF THE INVENTION

### 1. Field of the Invention

The present invention, in an aspect thereof, relates to, for example, a control device for controlling an electronic apparatus capable of communications with an external server and of voice information input.

### 2. Description of the Related Art

Dialogue devices have been developed that respond to the voice of the user. A dialogue system has been also developed that connects a dialogue device to a server over a communications network for voice recognition on the server. This dialogue system enables the dialogue device to conduct a search for information related to a response by using a result of voice recognition received from the server.

Japanese Unexamined Patent Application Publication, Tokukai, No. 2003-140691 discloses voice utilization system capable of performing verbal dialogues without having to sacrifice dialogue performing efficiency in the event of an error recognition and a recognition error. This voice utilization system includes a plurality of voice recognition engines each having a different voice recognition algorithm and switches between these engines to change voice recognition algorithms.

### SUMMARY OF THE INVENTION

This conventional art involves the use of voice recognition engines and therefore tends to add to the computing executed by the server to deal with environmental noise, hence disadvantageously adding to server load.

The present invention, in an aspect thereof, has been made in view of these problems and has an object to provide, for example, a control device for an electronic apparatus capable of reducing server load.

To address the problems, the present invention, in an aspect thereof, is directed to a control device for controlling an electronic apparatus capable of communicating with an external server and receiving an input of voice information, the control device including: a voice recognition unit configured to perform voice information recognition on the inputted voice information; and a voice recognition control unit configured to transmit to the server the voice information and a voice recognition request that the server perform voice information recognition on the voice information and to determine whether or not there has occurred a recognition error in a voice recognition result produced by the server, wherein when there have occurred more recognition errors in the server than a prescribed number, the voice recognition control unit suspends the transmission of the voice recognition request to the server.

To address the problems, the present invention, in an aspect thereof, is directed to a method of controlling an electronic apparatus capable of communicating with an external server and receiving an input of voice information, the method including: the voice recognition step of performing voice information recognition on the inputted voice information; and the voice recognition control step of transmitting to the server the voice information and a voice recognition request that the server perform voice information recognition on the voice information and of determining whether or not there has occurred a recognition error in a voice recognition result produced by the server, wherein when there have occurred more recognition errors than a prescribed number, the voice recognition control step suspends the transmission of the voice recognition request to the server.

To address the problems, the present invention, in an aspect thereof, is directed to an electronic apparatus including: at least one voice input device; at least one communications device configured to communicate with an external server; and at least one control device configured to implement: a voice recognition process of performing voice information recognition on voice information fed to the voice input device; and a voice recognition control process of controlling the communications device to transmit to the server the voice information and a voice recognition request that the server perform voice information recognition on the voice information and of determining whether or not there has occurred a recognition error in a voice recognition result produced by the server, wherein when there have occurred more recognition errors in a voice recognition process on the server than a prescribed number, the transmission of the voice recognition request to the server is suspended in the voice recognition control process.

The present invention, in an aspect thereof, advantageously reduces server load.

### BRIEF DESCRIPTION OF THE DRAWINGS

FIG. 1 is a block diagram of a configuration of a communications system including an electronic apparatus in accordance with an embodiment of the present invention and a server.

FIG. 2 is a flow chart representing a flow of an operation of the communications system.

FIG. 3 is a flow chart representing a flow of an operation of an electronic apparatus in a variation example.

### DETAILED DESCRIPTION OF THE INVENTION

The following will describe embodiments of the present invention in detail. Members of an embodiment that have the same function as members of another embodiment are indicated by the same reference numerals and description thereof may be omitted for convenience of description.

### Embodiment 1

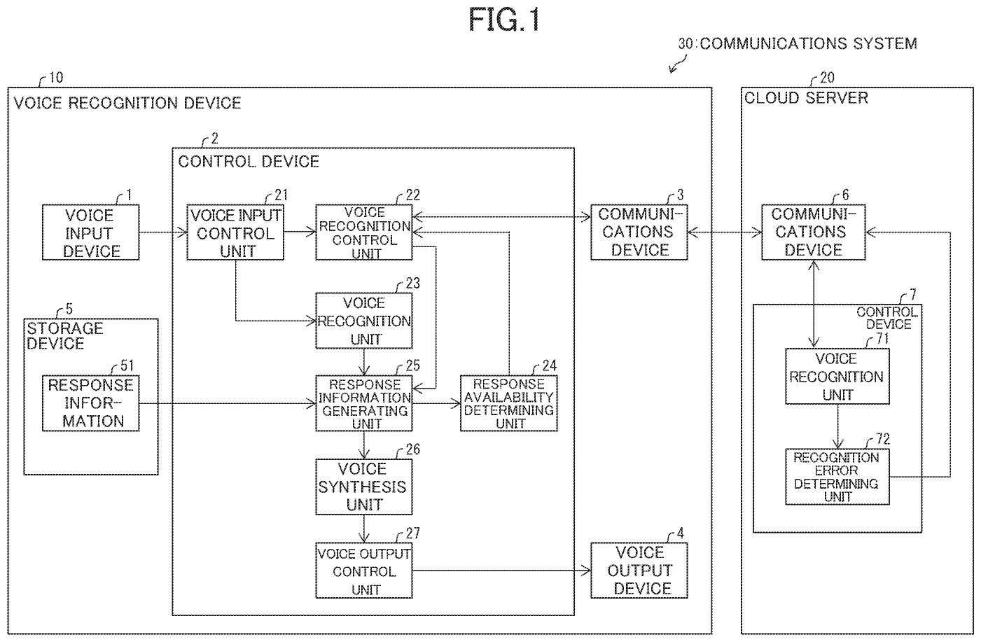

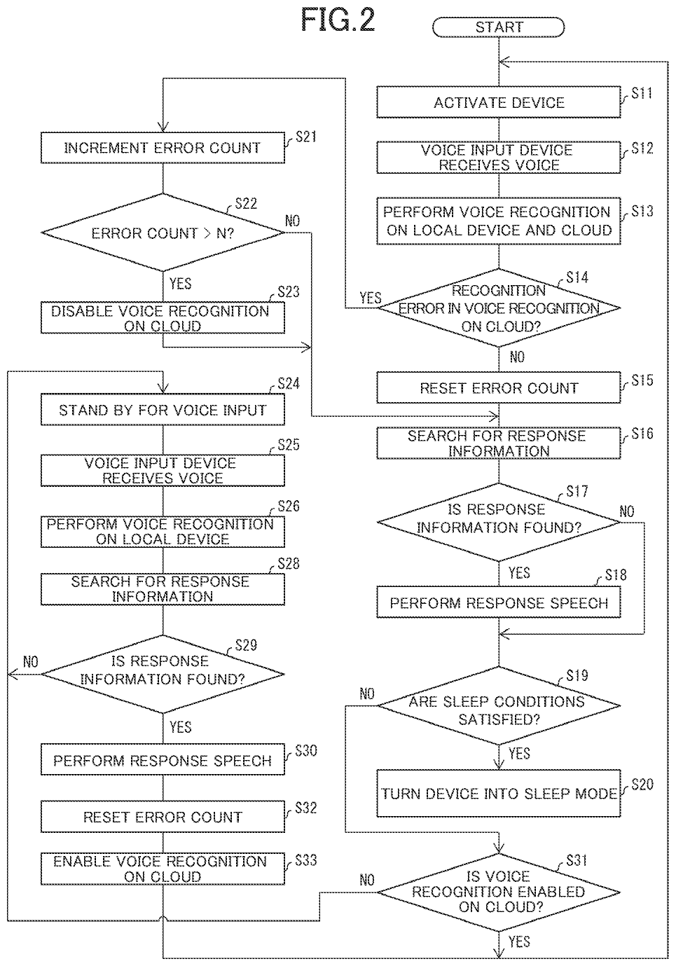

A description is now given of an embodiment of the present invention with reference to FIGS. 1 and 2.

### Brief Description of Communications System 30

A communications system 30 enables verbal dialogues between the user and a voice recognition device (electronic apparatus) 10. As a specific example, the communications system 30 enables a verbal dialogue by the voice recognition device 10 outputting response voice, “Good morning. It's fine today,” to the user in response to the user saying, “Good morning,” to the voice recognition device 10.

The communications system 30 includes the voice recognition device 10 and a cloud server 20 (server). Each of the voice recognition device 10 and the cloud server 20 is capable of voice information recognition. The voice recognition device 10 acquires voice produced by the user to recognize the information the voice carries (“voice information recognition”).

The voice recognition device 10 and the cloud server 20 can communicate with each other. This configuration enables the voice recognition device 10, having acquired voice produced by the user, to transmit the information carried by the voice (“voice information”) to the cloud server 20. The cloud server 20, provided external to the voice recognition device 10, acquires voice information from the voice recognition device 10 and upon receiving a voice recognition request from the voice recognition device 10, performs voice information recognition on the acquired voice information.

### Configuration of Major Components of Voice Recognition Device 10

FIG. 1 is a block diagram of an exemplary configuration of major components of the voice recognition device 10 and the cloud server 20 both included in the communications system 30. The voice recognition device 10 includes a voice input device 1, a control device 2, a communications device 3, a voice output device 4, and a storage device 5. There are provided a single voice input device 1, a single control device 2, a single communications device 3, a single voice output device 4, and a single storage device 5 in the present embodiment. Alternatively, there may be provided two or more of each of these control blocks.

The voice input device 1 picks up voice produced in the surroundings of the voice recognition device 10 to convert the voice to voice information for input to the control device 2 (voice input control unit 21). The voice input device 1 may be a microphone provided in the voice recognition device 10 and may be an input terminal for a voice information input from a microphone provided external to the voice recognition device 10. The voice output device 4 converts voice information to voice for output. The voice output device 4 may be a speaker provided in the voice recognition device 10 and may be an output terminal for a voice information output to a speaker provided external to the voice recognition device 10.

The communications device 3 communicates with the cloud server 20 for transmission and reception of various information. Specifically, the communications device 3 acquires voice information from the control device 2 (voice input control unit 21 and voice recognition control unit 22) for transmission to the cloud server 20 (voice recognition control step, voice recognition control). The communications device 3 transmits a voice recognition request to the cloud server 20 to request voice information recognition (voice recognition control step, voice recognition control). The communications device 3 also receives a second voice recognition result and a recognition error determination result from the cloud server 20 for output to the control device 2 (voice recognition control unit 22). The recognition error determination result is a result of the recognition of voice information performed by the cloud server 20.

The control device 2 controls all the functions of the voice recognition device 10. The control device 2 includes the voice input control unit 21, the voice recognition control unit 22, a voice recognition unit 23, a response availability determining unit 24, a response information generating unit 25, a voice synthesis unit 26, and a voice output control unit 27.

Upon acquiring voice information from the voice input device 1, the voice input control unit 21 forwards the voice information to the voice recognition control unit 22 and the voice recognition unit 23. The voice recognition control unit 22 transmits the voice information received from the voice input control unit 21 to the cloud server 20 via the communications device 3.

The voice recognition control unit 22 determines, on the basis of a recognition error determination result received from the cloud server 20 via the communications device 3, whether or not the second voice recognition result, which is a result of the recognition of voice information performed by the cloud server 20, is a recognition error. The voice recognition control unit 22, upon determining that there is no recognition error, forwards the second voice recognition result to the response information generating unit 25. The voice recognition unit 23 performs voice information recognition on the voice information received from the voice input control unit 21 and forwards a first voice recognition result that is a result of the voice recognition to the response information generating unit 25.

The response availability determining unit 24 determines whether or not the response information generating unit 25 has successfully generated response information. The response availability determining unit 24 forwards a result of this determination to the voice recognition control unit 27.

Upon receiving a response error (i.e., a determination that the response information generating unit 25 has failed to generate response information) from the response availability determining unit 24 more than a prescribed number of times, the voice recognition control unit 22 may stop the transmission of the voice recognition request to the cloud server 20.

The response information generating unit 25 searches the storage device 5 to generate response information associated in advance with the voice information on the basis of either one or both of the first voice recognition result and the second voice recognition result. For instance, when a quick reaction from the voice recognition device 10 is needed, the response information generating unit 25 may search the storage device 5 for response information by relying preferentially on the first voice recognition result. Alternatively, the response information generating unit 25 may search the storage device 5 for response information by relying on both the first voice recognition result and the second voice recognition result, in order to avoid unsuitable response speeches.

If only one piece of response information has been found for the recognized voice information, the same search results are obtained. If two or more pieces of response information have been found for the recognized voice information, a suitable piece of response information is selected depending on the priority levels of the two or more pieces of response information. When two or more different pieces of response information have been found that have the same priority level, one of the pieces of response information may be selected at random. Each piece of response information has a predetermined priority level.

The voice synthesis unit 26 synthesizes response voice on the basis of the response information generated by the response information generating unit 25 to forward the response voice to the voice output control unit 27. The voice output control unit 27 controls the voice output function of the voice recognition device 10. Specifically the voice output control unit 27 controls the voice output device 4 to output the synthesized response voice.

The voice recognition control unit 22 counts the number of times that there has occurred a recognition error in the cloud server 20. If the number of times that there has occurred a recognition error exceeds a prescribed number of times, the voice recognition control unit 22 suspends the transmission of the voice recognition request to the cloud server 20. The response information generating unit 25 searches the storage device 5 to generate response information on the basis of the inputted first voice recognition result.

On the other hand, if the number of times that there has occurred a recognition error is less than or equal to the prescribed number of times, the voice recognition control unit 22 outputs the second voice recognition result to the response information generating unit 25. The response information generating unit 25 searches the storage device 5 to generate response information on the basis of either one or both of the inputted first voice recognition result and the inputted second voice recognition result.

According to this particular configuration, the voice recognition control unit 22 suspends the transmission of the voice recognition request to the cloud server 20 if the number of times that there has occurred a recognition error as determined by the voice recognition control unit 22 exceeds the prescribed number. The configuration thus exempts the cloud server 20 from having to perform unnecessary voice information recognition.

According to the configuration, the response information generating unit 25 generates response information on the basis of the first voice recognition result if the number of times that there has occurred a recognition error as determined by the voice recognition control unit 22 exceeds the prescribed number. The configuration thus reduces the load on the cloud server 20 and is still capable of generating response information. The configuration can hence reduce the load on the cloud server 20. The determination as to whether or not the number of times that there has occurred a recognition error exceeds the prescribed number may be done based on the number of consecutive recognition errors in excess of the prescribed number and may be done based on the number of recognition errors in a prescribed period of time in excess of the prescribed number.

If the number of times that there has occurred a recognition error as determined by the voice recognition control unit 22 is less than or equal to the prescribed number, the response information generating unit 25 generates response information on the basis of either one or both of the first voice recognition result and the second voice recognition result. This particular configuration can reduce generation of unsuitable response information. For instance, when the first voice recognition result is not a recognition error, and the second voice recognition result is a recognition error, the response information generating unit 25 searches for response information on the basis of the first voice recognition result. On the other hand, when the second voice recognition result is not a recognition error, and the first voice recognition result is a recognition error, the response information generating unit 25 searches for response information on the basis of the second voice recognition result. Furthermore, when neither the first voice recognition result nor the second voice recognition result is a recognition error, the response information generating unit 25 searches for response information on the basis of both the first voice recognition result and the second voice recognition result. If two or more different pieces of response information are found in the search, one of the pieces of response information is selected either at random or on the basis of the predetermined priority levels thereof.

The storage device 5 contains various data for use by the voice recognition device 10. In accordance with the present embodiment, the storage device 5 contains at least response information 51. The response information 51 may be, for example, scenario information associated in advance with prescribed voice information. Scenario information is a collection of reactions to recognized speech.

### Configuration of Major Components of Cloud Server 20

The cloud server 20 includes a communications device 6 and a control device 7. The communications device 6 communicates with the voice recognition device 10 for transmission and reception of various information. Specifically, the communications device 6 receives voice information and a voice recognition request from the voice recognition device 10 for output to the control device 7.

The control device 7 controls all the functions of the cloud server 20. The control device 7 includes a voice recognition unit 71 and a recognition error determining unit 72. If the control device 7 has received a voice recognition request, the voice recognition unit 71 performs voice information recognition on the received voice information and forwards the second voice recognition result, which is a result of the recognition of voice information performed by the voice recognition unit 71, to the communications device 6. On the other hand, if the control device 7 has not received a voice recognition request, the voice recognition unit 71 does not perform voice information recognition. The recognition error determining unit 72 determines whether or not the result of the recognition of voice information performed by the voice recognition unit 71 is a recognition error and forwards a recognition error determination result to the communications device 6. The communications device 6 transmits either the received second voice recognition result or the received recognition error determination result to the voice recognition device 10. The present embodiment describes the communications system 30 as including a single cloud server 20. Alternatively, the communications system 30 may include a plurality of cloud servers 20.

### Brief Description of Operation of Communications System 30

A brief description will be given next of an operation of the communications system 30 with reference to FIG. 2. FIG. 2 is a flow chart representing a flow of an operation of the communications system 30. Throughout the following description, the voice recognition device 10 may be referred to as the “local device” or the “device,” and the cloud server 20 as the “cloud.”

The process starts in step S11 (hereinafter, “step” is omitted) where the device is activated. The process then proceeds to step S12. The device being “activated” in S11 in this example means that the voice recognition function of the device, or the voice recognition device 10, is on.

The voice input device 1 receives a voice input in S12 before the process proceeds to S13. More specifically, in S12, the voice input device 1 receives a voice input, converts the received voice input to voice information, and sends the voice information obtained by the conversion to the control device 2.

The local device and the cloud perform voice recognition in S13 (voice recognition step, voice recognition) before the process proceeds to S14. More specifically the voice input control unit 21 sends the voice information fed from the voice input device 1 to the voice recognition control unit 22 and the voice recognition unit 23. The communications device 3 sends the voice information fed from the voice recognition control unit 22 to the voice recognition unit 71 via the communications device 6 in the cloud server 20, so that the voice recognition unit 71 can perform voice recognition (cloud-based voice recognition) on the voice information. The recognition error determining unit 72 determines whether or not the result of the voice recognition contains a recognition error.

Meanwhile, the voice recognition unit 23 performs voice recognition on the incoming voice information (local-based voice recognition). The voice information recognition in the voice recognition unit 23 and the voice recognition unit 71 in this example is conversion of voice information to text data. Accordingly, the result of the conversion of the voice information to text data by the voice recognition unit 23 is sent as a first recognition result to the response information generating unit 25. Meanwhile, the result of the conversion of the voice information to text data by the voice recognition unit 71 is sent as a second recognition result from the voice recognition control unit 22 to the response information generating unit 25 via the communications device 6 and the communications device 3.

Both the first recognition result and the second recognition result contain a result indicating whether or not the voice information has been successfully converted to text data and if the voice information has been successfully converted to text data, the resultant text data.

It is determined in S14 whether or not the result of the voice recognition in the cloud is a recognition error (voice recognition control step, voice recognition control). In this example, if the recognition error determination result fed from the recognition error determining unit 72 contains a result that the voice information has not been successfully converted to text data, the voice recognition control unit 22 determines that there has occurred a recognition error, in other words, the voice recognition control unit 22 determines that the voice recognition result is a recognition error. If it is determined in S14 that the result of the cloud-based voice recognition is a recognition error (YES), the process proceeds to S21.

On the other hand, if it is determined in S14 that the result of the cloud-based voice recognition is not a recognition error (NO), the process proceeds to S15 where the voice recognition control unit 22 resets the error count and forwards either one or both of the first voice recognition result and the second voice recognition result to the response information generating unit 25. The process then proceeds to S16. Resetting the error count in this example is to set the count back to 0 when the number of times that there has occurred a recognition error is greater than or equal to 1.

The response information generating unit 25 searches the storage device 5 for the response information 51 in S16 before the process proceeds to S17. The response information 51 in this example is text data associated with the text data obtained by the conversion in the voice recognition performed by the voice recognition unit 23 (voice recognition unit 71). For instance, when the voice recognition gives text data, “Good morning,” through conversion, the response information 51 is text data, such as “Good morning. It's fine today,” that is associated with “Good morning.” This text data association is predefined.

It is determined in S17 whether or not the response information searched for in S16 has been found. More specifically, the response information generating unit 25 searches the storage device 5 for the response information 51 associated with the text data obtained by the conversion of the voice information fed from the voice recognition unit 23 (voice recognition unit 71) and determines whether or not the response information 51 has been found. If the response information 51 has been found (YES), the process proceeds to S18. On the other hand, if the response information 51 has not been found (NO), the process proceeds to S19.

A response speech is made in S18. More specifically, the response information (text data) found in S17 is send to the voice synthesis unit 26 where response voice is synthesized. The response voice is synthesized in this example from the text data (response information) as the voice data to be vocalized. This synthesized voice data is sent to the voice output control unit 27 where the voice data is converted to analog data for a voice output from the voice output device 4, for example, a speaker. The voice output device 4 then outputs the analog data fed from the voice output control unit 27 in the form of response speech voice. For instance, when the voice recognition gives text data, “Good morning,” through conversion as in the foregoing example, the voice output device 4 outputs “Good morning. It's fine today,” as the response speech voice. As the response speech is finished in S18, the process proceeds to S19.

The control device 2 checks in S19 whether or not the sleep conditions are being satisfied. If the sleep conditions are satisfied (YES), the process proceeds to S20. The control device 2 checks whether or not the sleep conditions are being satisfied, by determining whether or not the voice input device 1 in the voice recognition device 10 is on. For instance, if it is determined that the voice input device 1 in the voice recognition device 10 is off, it is determined that the sleep conditions are being satisfied; if it is determined that the voice input device 1 in the voice recognition device 10 is on, it is determined that the sleep conditions are not being satisfied.

The control device 2 turns the device into sleep mode in S20. In sleep mode, the voice recognition function of the device, or the voice recognition device 10, is off. The operation of the device in sleep mode will be described in Variation Example 1 below.

On the other hand, if the sleep conditions are not being satisfied in S19 (NO), the process proceeds to S31. It is determined in S31 whether or not the cloud-based voice recognition is disabled. If it is determined that the cloud-based voice recognition is not disabled (enabled) (YES), the process proceeds to S11; if it is determined that the cloud-based voice recognition is disabled (NO), the process proceeds to S24.

If it is determined in S14 that the voice recognition result is a recognition error, the error count is incremented in S21. The process then proceeds to S22. The error count is incremented by the voice recognition control unit 22. Incrementing the error count is to increase the error count (number of times that there has occurred a recognition error, including 0) by 1.

It is determined in S22 whether or not the error count has exceeded a prescribed number of times (“prescribed number N” or “N”). The prescribed number N may have any value greater than or equal to 2. If the prescribed number N is increased, it takes longer to disable the cloud-based voice recognition in S23 (detailed later), which increases the workload of the cloud server 20. For this reason, the prescribed number N is preferably smaller. In other words, N is preferably closer to 2.

If the error count exceeds the prescribed number N in S22 (YES), the process proceeds to S23. On the other hand, if the error count is less than or equal to N in S22 (NO), the process proceeds to S16.

The cloud-based voice recognition is disabled in S23 before the process proceeds to S16. More specifically, the voice recognition control unit 22 stops (suspends) the output of the voice recognition request. A voice recognition request is a control signal for the execution of voice recognition in the voice recognition unit 71 in the cloud server 20.

A voice input is awaited in S24. The process then proceeds to S25 where the voice input device 1 receives voice (receives a voice input). The process then proceeds to S26 where the local device performs voice recognition before the process proceeds to S28. More specifically, in S26, the voice recognition unit 23 in the voice recognition device 10 performs voice information recognition and forwards the result of the voice information recognition, or the first voice recognition result, to the response information generating unit 25 before the process proceeds to S28.

In S28, the response information generating unit 25 searches the storage device 5 for the response information 51 based on the first voice recognition result before the process proceeds to S29.

In S29, it s determined whether or not the response information 51 has been found in the search for the response information 51 in S28. If the response information 51 has been found (YES), the process proceeds to S30. On the other hand, if the response information 51 has not been found in S29 (NO), the process returns to S24.

A response speech is made in S30. The response speech here is the same as the response speech in S18 above. More specifically, the response information 51 (text data) found in S29 is sent to the voice synthesis unit 26 where response voice is synthesized. The response voice is synthesized in this example from the text data (response information 51) as the voice data to be vocalized. This synthesized voice data is sent to the voice output control unit 27 where the voice data is converted to analog data for a voice output from the voice output device 4, for example, a speaker. The voice output device 4 then outputs the analog data fed from the voice output control unit 27 in the form of response speech voice. For instance, when the voice recognition gives text data, “Good morning,” through conversion as in the foregoing example, the voice output device 4 outputs “Good morning. It's fine today,” as the response speech voice. As the response speech is finished in S30, the process proceeds to S32.

The voice recognition control unit 22 resets the error count in S32 before the process proceeds to S33 where the voice recognition control unit 22 enables the cloud-based voice recognition. The process then returns to S11.

### VARIATION EXAMPLE 1

A description is now given of Variation Example 1 of the present invention. This variation example will focus on operation after the voice recognition device 10 goes into sleep mode. When the voice recognition device 10 is in sleep mode, the voice recognition unit 23 may not perform voice information recognition, and voice recognition may be disabled on the cloud server 20. More specifically, the voice recognition control unit 22 stops (suspends) the transmission of the inputted voice information and the inputted voice recognition request to the cloud server 20. This particular configuration can reduce power consumption of the voice recognition device 10 and also reduce the workload of the cloud server 20.

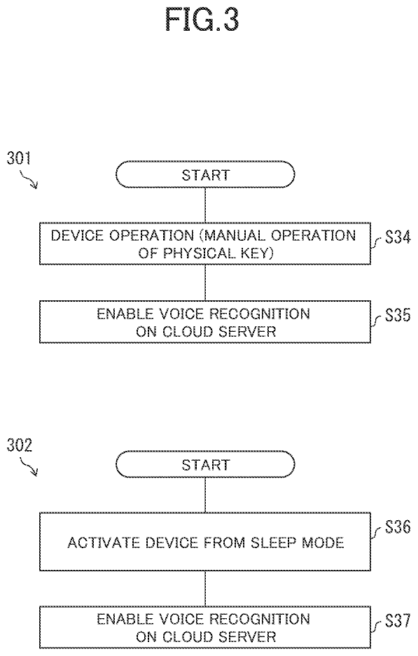

The voice recognition device 10 may go out of sleep mode in the following manner. As an example, as in the flow chart denoted by reference numeral 301 in FIG. 3, voice recognition may be enabled on the cloud server 20 (S35) in response to any kind of manual operation on the voice recognition device 10 (e.g., manual operation of a physical key of the voice recognition device 10) (S34). More specifically, if the voice recognition device 10 receives any kind of manual operation while voice recognition is disabled on the cloud server 20, the voice recognition control unit 22 transmits the inputted voice information and the inputted voice recognition request to the cloud server 20. In other words, these processes, which have been stopped (suspended), are re-started. Restarting the processes activates the voice recognition device 10, in other words, turning on the voice recognition function. In other words, the voice recognition device 10 can be re-activated without requiring any inputs from the user.

Then, as in the flow chart denoted by reference numeral 302 in FIG. 3, voice recognition may be enabled on the cloud server 20 (S37) in response to re-activation of the voice recognition device 10 from sleep mode (S36). More specifically, if the voice recognition device 10 is activated from sleep mode while voice recognition is disabled on the cloud server 20, the voice recognition control unit 22 transmits the inputted voice information and the inputted voice recognition request to the cloud server 20. In other words, these processes, which have been stopped (suspended), are re-started,

### VARIATION EXAMPLE 2

Voice recognition may be enabled and disabled, for example, by one of the following triggers or events. As an example, the voice recognition device 10 may include a timer (not shown), so that voice recognition can be disabled during midnight (e.g., from 0 A.M. to 3 A.M.).

Alternatively, the voice recognition device 10 may include a GPS (global positioning system) receiver (not shown), so that voice recognition can be enabled when the voice recognition device 10 is in a prescribed location and disabled when the voice recognition device 10 is in other locations.

As another alternative, the voice recognition device 10 may include an acceleration sensor, so that voice recognition can be disabled when acceleration in excess of a threshold value is detected because the voice recognition device 10 would be moving.

### Embodiment 2: Software Implementation

The control blocks of the control device 2 (particularly, the voice recognition control unit 22, the voice recognition unit 23, the response availability determining unit 24, and the response information generating unit 25) for the voice recognition device 10 may be implemented by logic circuits (hardware) fabricated, for example, in the form of an integrated circuit (IC chip) and may be implemented by software.

In the latter form of implementation, the control device 2 includes a computer that executes instructions from programs or software by which various functions are provided. This computer includes among others at least one processor (control device) and at least one storage medium containing the programs in a computer-readable format. The processor in the computer then retrieves and runs the programs contained in the storage medium, thereby achieving the object of an aspect of the present invention.

The processor may be, for example, a CPU (central processing unit). The storage medium may be a “non-transitory, tangible medium” such as a ROM (read-only memory), a tape, a disc/disk, a card, a semiconductor memory, or programmable logic circuitry. The control device 2 may further include, for example, a RAM (random access memory) for loading the programs. The programs may be supplied to the computer via any transmission medium (e.g., over a communications network or by broadcasting waves) that can transmit the programs. The present invention, in an aspect thereof, encompasses data signals on a carrier wave that are generated during electronic transmission of the programs.

### General Description

The present invention, in aspect 1 thereof, is directed to a control device (2) for controlling an electronic apparatus (voice recognition device 10) capable of communicating with an external server (cloud server 20) and receiving an input of voice information, the control device (2) including: a voice recognition unit (23) configured to perform voice information recognition on the inputted voice information; and a voice recognition control unit (22) configured to transmit to the server the voice information and a voice recognition request that the server perform voice information recognition on the voice information and to determine whether or not there has occurred a recognition error in a voice recognition result produced by the server, wherein when there have occurred more recognition errors than a prescribed number, the voice recognition control unit suspends the transmission of the voice recognition request to the server.

In this particular configuration, the voice recognition control unit suspends the transmission of the voice recognition request to the server when the number of times that there has occurred a recognition error as determined by the voice recognition control unit exceeds the prescribed number (of times). The configuration hence exempts the server from having to perform unnecessary voice information recognition, thereby reducing server load.

In aspect 2 of the present invention, the control device (2) of aspect 1 may be configured so as to further include a response information generating unit (25) configured to generate response information associated in advance with the voice information based on either or both of a first voice recognition result and a second voice recognition result, wherein the first voice recognition result is a voice recognition result produced by the voice recognition unit (23), and the second voice recognition result is the voice recognition result produced by the server (cloud server 20). This particular configuration can reduce generation of unsuitable response information.

In aspect 3 of the present invention, the control device (2) of aspect 2 may be configured such that when the voice recognition control unit (22) determines that there have occurred more recognition errors than the prescribed number, the response information generating unit (25) generates the response information based on the first voice recognition result. This particular configuration reduces server load and is still capable of generating response information.

In aspect 4 of the present invention, the control device (2) of aspect 2 or 3 may be configured such that when the voice recognition control unit (22) determines that there have occurred as many recognition errors as the prescribed number or that there have occurred less recognition errors than the prescribed number, the response information generating unit (25) generates the response information based on either or both of the first voice recognition result and the second voice recognition result. This particular configuration can reduce generation of unsuitable response information.

In aspect 5 of the present invention, the control device (2) of aspect 2 or 3 may be configured such that when the electronic apparatus (voice recognition device 10) is in sleep mode, the voice recognition unit (23) does not perform the voice information recognition, and the voice recognition control unit (22) does not transmit the voice information and the voice recognition request to the server (cloud server 20). This particular configuration can reduce power consumption of the electronic apparatus and also reduce server load.

The present invention, in aspect 6 thereof, is directed to a method of controlling an electronic apparatus (voice recognition device 10) capable of communicating with an external server (cloud server 20) and receiving an input of voice information, the method including: the voice recognition step of performing voice information recognition on the inputted voice information; and the voice recognition control step of transmitting to the server the voice information and a voice recognition request that the server perform voice information recognition on the voice information and of determining whether or not there has occurred a recognition error in a voice recognition result produced by the server, wherein when there have occurred more recognition errors than a prescribed number, the voice recognition control step suspends the transmission of the voice recognition request to the server. This particular method can achieve similar effects to those achieved by aspect 1.

The present invention, in aspect 7 thereof, is directed to an electronic apparatus (voice recognition device 10) including: at least one voice input device (1); at least one communications device (3) configured to communicate with an external server (cloud server 20); and at least one control device (2) configured to implement: a voice recognition process of performing voice information recognition on voice information fed to the voice input device; and a voice recognition control process of controlling the communications device to transmit to the server the voice information and a voice recognition request that the server perform voice information recognition on the voice information and of determining whether or not there has occurred a recognition error in a voice recognition result produced by the server, wherein when the voice recognition control process determines that there have occurred more recognition errors than a prescribed number, the transmission of the voice recognition request to the server is suspended. This particular configuration can achieve similar effects to those achieved by aspect 1.

The control device of any aspect of the present invention may be implemented on a computer, in which case the present invention encompasses a control program that causes a computer to function as the various units (software elements) of the control device, thereby implementing the control device on the computer, and also encompasses a non-transitory computer-readable storage medium containing the control program.

### Additional Remarks

The present invention is not limited to the description of the embodiments above and may be altered within the scope of the claims. Embodiments based on a proper combination of technical means disclosed in different embodiments are encompassed in the technical scope of the present invention. Furthermore, new technological features can be created by combining different technical means disclosed in the embodiments.

What is claimed is:

1. A control device for controlling an electronic apparatus capable of communicating with an external server and receiving an input of voice information, the control device comprising:
a voice recognition unit configured to perform voice information recognition on the inputted voice information; and
a voice recognition control unit configured to transmit to the server the voice information and a voice recognition request that the server perform voice information recognition on the voice information and to determine whether or not there has occurred a recognition error in a voice recognition result produced by the server, wherein
when there have occurred more recognition errors than a prescribed number, the voice recognition control unit suspends the transmission of the voice recognition request to the server.

2. The control device according to claim 1, further comprising a response information generating unit configured to generate response information associated in advance with the voice information based on either or both of a first voice recognition result and a second voice recognition result, wherein
the first voice recognition result is a voice recognition result produced by the voice recognition unit, and
the second voice recognition result is the voice recognition result produced by the server.

3. The control device according to claim 2, wherein when the voice recognition control unit determines that there have occurred more recognition errors than the prescribed number, the response information generating unit generates the response information based on the first voice recognition result.

4. The control device according to claim 2, wherein when the voice recognition control unit determines that there have occurred as many recognition errors as the prescribed number or that there have occurred less recognition errors than the prescribed number, the response information generating unit generates the response information based on either or both of the first voice recognition result and the second voice recognition result.

5. The control device according to claim 1, wherein when the electronic apparatus is in sleep mode, the voice recognition unit does not perform the voice information recognition, and the voice recognition control unit does not transmit the inputted voice information and the inputted voice recognition request to the server.

6. A non-transitory computer-readable medium containing a control program for causing a computer to function as the control device according to claim 1, the control program causing the computer to function as the voice recognition unit and the voice recognition control unit.

7. A method of controlling an electronic apparatus capable of communicating with an external server and receiving an input of voice information, the method comprising:
the voice recognition step of performing voice information recognition on the inputted voice information; and
the voice recognition control step of transmitting to the server the voice information and a voice recognition request that the server perform voice information recognition on the voice information and of determining whether or not there has occurred a recognition error in a voice recognition result produced by the server, wherein
when there have occurred more recognition errors than a prescribed number, the voice recognition control step suspends the transmission of the voice recognition request to the server.

8. An electronic apparatus comprising:
at least one voice input device;
at least one communications device configured to communicate with an external server; and
at least one control device configured to implement:
a voice recognition process of performing voice information recognition on voice information fed to the voice input device; and
a voice recognition control process of controlling the communications device to transmit to the server the voice information and a voice recognition request that the server perform voice information recognition on the voice information and of determining whether or not there has occurred a recognition error in a voice recognition result produced by the server, wherein
when the voice recognition control process determines that there have occurred more recognition errors than a prescribed number, the transmission of the voice recognition request to the server is suspended.
